(19) United States
(12) Patent Application Publication
(10) Pub. No.: US 2003/0214679 A1
(43) Pub. Date: Nov. 20, 2003

(54) Communication apparatus

(76) Inventor: Kazutoshi Ishikawa, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/391,655

(22) Filed: Mar. 20, 2003

(30) Foreign Application Priority Data
Mar. 20, 2002 (JP) 2002-079441

(51) Int. Cl. H04N 1/00; H04N 1/32

(52) U.S. Cl. 358/434; 358/468; 358/440

(57) ABSTRACT

A communication apparatus displaying the state of transmission of image data in a manner that can be easily confirmed by an operator. The communication apparatus comprises an image storage portion for storing the image data that are to be transmitted, a display control portion storing destination information related to the destinations to which the image data will be transmitted and the state of transmission of the data to the destinations, a display portion for displaying the destination information, and a main control portion which when the broadcast communication of one item of data is executed causes the display portion to display a list of the destination information of all destinations to which the data are to be transmitted and displaying the destination information in a manner, determined in advance, which varies depending upon the state of transmission.

### BACKGROUND OF THE INVENTION

1. Field of the Invention

This invention relates to a communication apparatus equipped with a broadcast communication function for transmitting the same data to a plurality of destinations successively.

2. Description of the Related Art

A conventional communication apparatus such as facsimiles equipped with a broadcast communication function for transmitting the same image data to a plurality of destinations display, on a display portion, only the telephone number of a destination where a transmission is being performed. Further, the conventional communication apparatus prints, on a recording paper, a file list of destinations and a communication management report indicating whether the image data was properly transmitted. An operator of the communication apparatus takes a look at the file list that is displayed and the communication management report that is printed.

As a prior art of this kind, Japanese Unexamined Patent Publication Japanese Unexamined Patent Publication JP-A 9-65034 (1997) discloses an image communication apparatus comprising communication file managing means for managing a file in which the image data to be transmitted are stored in units of pages and for managing a communication state in order to minutely grasp the status of broadcast distribution, and control means for outputting a communication file report placing emphasis on the number of the file that is now being executed, on that destination/telephone number and on the status of that transmission, with reference to the communication file managing means.

As another prior art, Japanese Unexamined Patent Publication Japanese Unexamined Patent Publication JP-A 2001-134358 (2001) discloses a method of displaying a text image in which when print of small size is displayed in order to increase an amount of information to be displayed at one time, information about a position and a range designated by the user is obtained, a part of the text in the text data is enlarged in accordance with the designation, and the enlarged portion and a non-enlarged portion are displayed in a mixed manner.

As a further prior art, Japanese Unexamined Patent Publication Japanese Unexamined Patent Publication JP-A 4-207639 (1992) discloses a selective call receiver with a display which displays, on a color LCD (liquid crystal display apparatus), certain specified characters among display information signals by a color different from other characters.

In the conventional communication apparatus that displays the telephone number only of the destination where the transmission is being performed, however, the operator is neither able to confirm the telephone numbers of all destinations nor to confirm the status where the transmission is taking place in the whole circumstances.

The image communication apparatus disclosed in Japanese Unexamined Patent Publication JP-A 9-65034 (1997) places emphasis on the number of the file that is now being executed, on the destination/telephone number and on the status of communication in a detailed communication file report that includes the file number, communication status, kind of communication, number of file pages accumulated, number of times calls have been made, the times that calls were made and destinations of the calls. When the communication file report is printed, the operator can confirm the content because the operator can carefully read the communication file report no matter how minute information is. When the communication file report is displayed on the display portion, however, an amount of information that is displayed is so large that the operator finds it very difficult to confirm at a glance the information that are displayed in an efficient manner even though the number of the file that is now being executed, destination/telephone number and communication status are displayed in an emphasized manner by being surrounded by a broken line. Besides, the display and expression emphasized by being surrounded by a broken line are subject to be poorly recognized from the standpoint of ergonomics. Therefore, the operator is difficult to confirm the communication status at a glance, and often is late in taking measures to deal with an emergency situation such as interruption of the communication.

Further, even when the method of displaying text image disclosed in Japanese Unexamined Patent Publication JP-A 2001-134358 (2001) is used for the communication apparatus, the display in an enlarged scale is not performed unless the operator designates desired information from the information displayed on the display portion while the image data are being transmitted, and the transmission status cannot be displayed in an enlarged scale unless the desired information is designated during the transmission. The selective call receiver with display disclosed in Japanese Unexamined Patent Publication JP-A 4-207639 (1992) displays particular characters with accent by displaying particular characters by a color different from other characters. However, accent of particular characters is not stressed unless the display portion is capable of displaying multi-colors like a color liquid crystal display apparatus.

### SUMMARY OF THE INVENTION

It is therefore an object of the invention to provide a communication apparatus which is capable of displaying a destination information and a state of transmission of the data in a manner so that they can easily be found by an operator.

The invention provides a communication apparatus equipped with a broadcast communication function for transmitting the same data to a plurality of destinations successively, comprising:

storage means for storing data to be transmitted, destination information related to the destinations to which the data are to be transmitted, and a state of transmission of the data to the destinations;

display means for displaying the destination information; and

display control means for controlling the display means so as to display a list of destination information of all destinations to which the data are to be transmitted when a broadcast communication function is to be executed and so as to display the respective destination information in a predetermined display mode in accordance with the respective states of transmission.

According to the invention, when the broadcast communication function is to be executed, on the display means is displayed the list of destination information of all destinations to which the data are to be transmitted, and the respective destination information in the predetermined display mode in accordance with the respective states of transmission of the data. Therefore, the operator of the communication apparatus can easily confirm the destination information of all destinations by taking a look at the display means, and to easily recognize the state of transmission of data to the destinations by the difference in the mode of displaying the destination information.

In the invention it is preferable that the state of transmission indicates an order of transmitting the data and whether the data are being transmitted, and the display control means controls the display means so as to display the destination information to arrange them in the order of transmission based upon the state of transmission and so as to display the destination information of the destination to which the data are being transmitted in a display mode different from that of the rest of destination information.

According to this invention, based on the state of transmission indicating the order of transmitting the data and whether the data are being transmitted, the destination information is displayed to arrange them in the order of transmission. The destination information of the destination to which the data are being transmitted are displayed in a display mode different from that of the rest of destination information. Accordingly, the operator can easily confirm the order of transmitting data to the destinations and the destination to which the data are now being transmitted by taking a look at the display means, and it is possible to correctly grasp the progress of the broadcast communication.

In the invention it is preferable that the display control means controls the display means so as to display the destination information by characters whose size differs depending upon the state of transmission.

According to the invention, the destination information is displayed by characters whose size differs depending upon the state of transmission. Therefore, the operator can easily distinguish and confirm the states of transmission such as “data transmitting”, “waiting for transmission” and “transmission finished”, by taking a look at the display means, and it is possible to correctly grasp the progress of the broadcast communication.

In the invention it is preferable that the display control means controls the display means so as to display the destination information by characters whose color differs depending upon the state of transmission.

According to the invention, the destination information is displayed by characters whose color differs depending upon the state of transmission. Therefore, the operator can easily distinguish and confirm the states of transmission such as “data transmitting”, “waiting for transmission” and “transmission finished”, by taking a look at the display means, and it is possible to correctly grasp the progress of the broadcast communication.

In the invention it is preferable that the display control means controls the display means so as to display a background of a region for displaying the destination information by a color that differs depending upon the state of transmission.

According to the invention, the background of the region for displaying the destination information is displayed by a color that differs depending upon the state of transmission. Therefore, the operator can easily distinguish and confirm the states of transmission such as “data transmitting”, “waiting for transmission” and “transmission finished”, by taking a look at the display means, and it is possible to correctly grasp the progress of the broadcast communication.

In the invention it is preferable that the display control means controls the display means so as to display, as the display mode of destination information of a destination to which the data are being transmitted, a color of the characters representing the destination information and a background color of a region displaying the destination information, inverted from the display mode of the rest of destination information.

According to the invention, the destination information of a destination to which the data are being transmitted is displayed with the color of the characters representing the destination information and the background color of the region displaying the destination information in a display mode inverted from the display mode of the rest of destination information. Therefore, the operator can easily confirm the destination to which the data are now being transmitted, by taking a look at the display means, and it is possible to correctly grasp the progress of the broadcast communication.

In the invention it is preferable that the display control means determines the display mode by combining at least two of a different character size, a different character color and a different background color in the region for displaying the characters.

According to the invention, the destination information is displayed in the display mode which is determined by combining at least two of the different character size, the different character color and the different background color in the region for displaying the characters. Therefore, the operator can easily distinguish and confirm the states of transmission such as “data transmitting”, “waiting for transmission” and “transmission finished”, by taking a look at the display means, and it is possible to correctly grasp the progress of the broadcast communication.

In the invention it is preferable that the destination information includes an organization belonging to the destination and/or a region of the destination, and the display control means controls the display means so as to display the destination information in a predetermined display mode corresponding to the organization and the region.

According to the invention, the destination information is displayed in the predetermined display mode corresponding to the organization and/or the region. Therefore, the operator can easily distinguish and confirm the organization belonging to the destination and/or the region of the destination, by taking a look at the display portion.

### BRIEF DESCRIPTION OF THE DRAWINGS

Other and further objects, features, and advantages of the invention will be more explicit from the following detailed description taken with reference to the drawings wherein:

FIG. 1 is a block diagram illustrating the constitution of a facsimile apparatus according to an embodiment of the invention;

FIG. 2 is a view illustrating a broadcast communication list on a display portion of the facsimile apparatus;

FIG. 3 is a view schematically illustrating a destination address management table stored in a display control portion;

FIG. 4 is a flowchart illustrating the procedure of operation of the facsimile apparatus;

FIG. 5 is a view illustrating the broadcast communication list on the display portion at step s4 in the flowchart of FIG. 4;

FIG. 6 is a view illustrating the broadcast communication list on the display portion at step s13 in the flowchart of FIG. 4;

FIG. 7 is a view illustrating the broadcast communication list on the display portion;

FIG. 8 is a view illustrating the broadcast communication list on the display portion;

FIG. 9 is a view illustrating the broadcast communication list on the display portion;

FIG. 10 is a view illustrating the broadcast communication list on the display portion;

FIG. 11 is a view illustrating the broadcast communication list on the display portion;

FIG. 12 is a view illustrating the broadcast communication list on the display portion;

FIG. 13 is a view illustrating the broadcast communication list on the display portion; and

FIG. 14 is a view illustrating the broadcast communication list on the display portion.

### DETAILED DESCRIPTION OF THE PREFERRED EMBODIMENTS

Now referring to the drawings, preferred embodiments of the invention are described below.

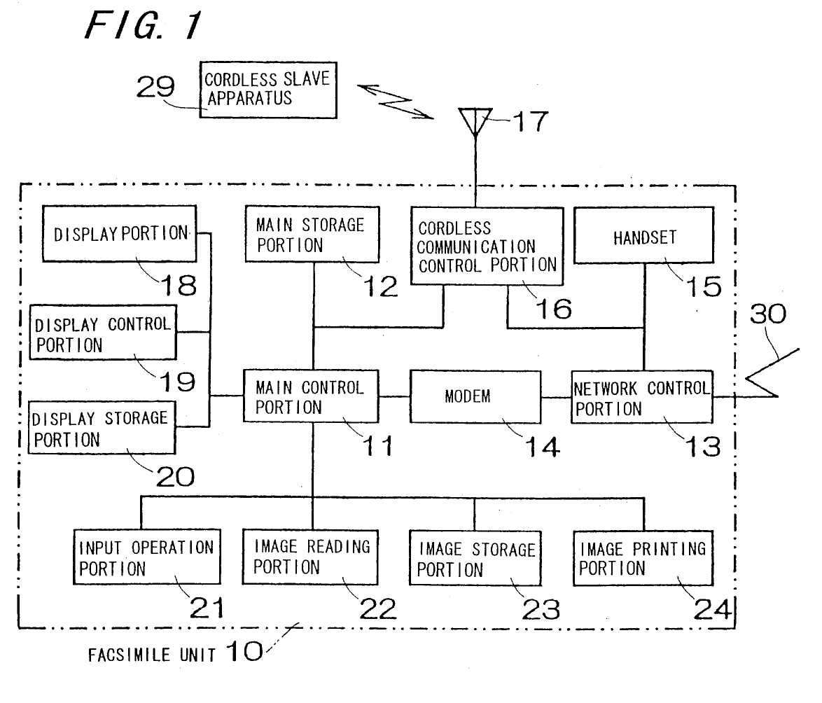

FIG. 1 is a block diagram illustrating the constitution of a facsimile apparatus 10 according to an embodiment of the invention. The facsimile apparatus 10 is a communication apparatus equipped with a broadcast communication function for transmitting the same image data to a plurality of destinations successively. The facsimile apparatus 10 includes a main control portion 11, a main storage portion 12, a network control portion 13, a modem 14, a handset 15, a cordless communication control portion 16, an antenna portion 17, a display portion 18, a display control portion 19, a display storage portion 20, an input operation portion 21, an image reading portion 22, an image storage portion 23 and an image printing portion 24.

The main control portion 11 is realized by, for example, a central processing unit (abbreviated as CPU) and works to totally control the facsimile apparatus 10 by executing a program stored in the main storage portion 12. The main control portion 11 also executes data compression for shortening the time to transmit the image data and the expansion for returning the compressed image data back to the initial information of a sequence of pixels. Concretely speaking, the main control portion 11 subjects the monochromatic image data to the compression and expansion of a modified Huffman coding method (abbreviated as MH method) a modified Reed method (abbreviated as MR method) and the like, and subjects the multi-color image data to the compression and expansion of the JPEG (Joint Photographic Experts Group) method recommended by the International Telecommunication Union Telecommunication Standardization Sector (abbreviated as ITU-T).

Further, the main control portion 11 converts multi-color image data expressed by red (abbreviated as R), green (abbreviated as G) and blue (abbreviated as B) which are the additive three primary colors used at the time of reading the image by the image reading portion 22; multi-color image data expressed by cyan (abbreviated as C), magenta (abbreviated as M) and yellow (abbreviated as Y) which are the subtractive three primary colors used at the time of printing by the image printing portion 24 to multi-color image data expressed by a uniform color space (CIE-Lab space) L*, a*, b* which is used for transmitting and receiving the image data among the communication apparatuses.

The main storage portion 12 is realized by including, for example, a nonvolatile memory such as a read-only memory (abbreviated as ROM) and a volatile memory such as a random access memory (abbreviated as RAM). The main storage portion 12 stores a program by which the main control portion 11 totally controls the facsimile apparatus 10, and temporarily stores the control instruction of the main control portion 11 during control of the facsimile apparatus 10.

The network control portion 13 can be electrically connected to the telephone line network 30, and works to monitor the status of the telephone line network 30 and to switch the electric connection of the modem 14, the handset 15 and the cordless communication control portion 16 to the telephone line network 30. The modem 14 modulates digital signals input through the main control portion 11 into analog signals adapted to the telephone line network 30 and outputs them to the network control portion 13, and demodulates analog signals from other communication apparatuses connected through the telephone line network 30 and input through the telephone line network 30 and network control portion 13 into digital signals adapted for printing the image through the image printing portion 24.

The handset 15 is used for telephone speech, and includes a receiver and a transmitter which are realized by using a speaker and a microphone. The cordless communication control portion 16 controls wireless communication with one or a plurality of cordless slave apparatuses 29 (a single apparatus is shown in FIG. 1) via an antenna 17. The cordless communication control portion 16 includes a tuner and the like for searching a communication channel for effecting the wireless communication with the cordless slave apparatus 29, for establishing the wireless communication, and for transmitting and receiving speech through electromagnetic waves.

The display portion 18 which is display means is realized by using a display apparatus such as a liquid crystal display apparatus (abbreviated as LCD) and displays various kinds of data. It is desired that the display portion 18 is capable of displaying a multi-color image. The display control portion 19 is realized by including CPU and RAM, and stores destination-classifying management tables, processes the destination-classifying management tables based on control signals from the main control portion 11 to form a broadcast communication list, and controls to display the formed broadcast communication list on the display portion 18. The display storage portion 20 is realized including a volatile memory such as RAM, and stores the broadcast communication list.

The input operation portion 21 is realized by an input apparatus such as a keyboard, a touch panel and the like, and is operated by the operator of the facsimile apparatus 10 to input various kinds of data and various kinds of instructions.

The image reading portion 22 is realized by an image reading apparatus such as a compression reading system comprising a combination of lenses and charge-coupled device (abbreviated as CCD) line sensor array or an contact image sensor system using a rod lens array and photodiodes. The image reading portion 22 reads an image formed on a document to be transmitted and copied and outputs image data.

The image storage portion 23 comprises a volatile memory such as RAM and a magnetic storage medium such as a hard disk drive (abbreviated as HDD). The image storage portion 23 stores the image data received through the telephone line network 30 and the image data read by the image reading portion 22.

The image printing portion 24 is realized by using, for example, a thermal transfer system, a thermal system, an electrophotographic system or an ink-jet system. The image printing portion 24 prints the image data received through the telephone line network 30, the image data read by the image reading portion 22, and a communication file report that will be described later, on printer paper.

In this embodiment, storage means comprises the image storage portion 23 and the display control portion 19, and display control means comprises the main control portion 11 and the display control portion 19.

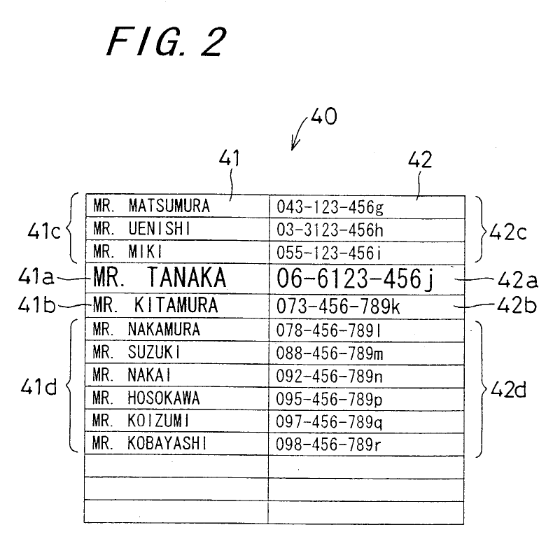

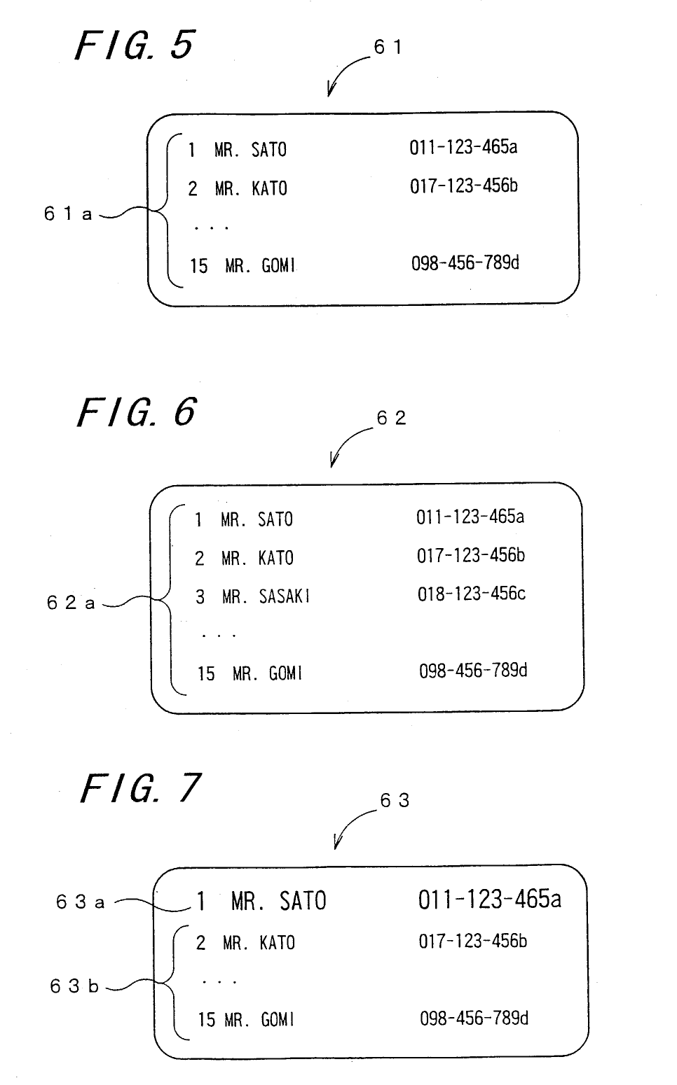

FIG. 2 is a view illustrating the display of a broadcast communication list 40 on the display portion 18 of the facsimile apparatus 10. The broadcast communication list 40 comprises destination information including at least the names 41 and the telephone numbers 42 of destinations to which the image data are to be transmitted, and the state of transmission including order of transmission. The order of transmission may be represented by numerals (see FIG. 5) or may be the arrangement of the names 41 and the telephone numbers 42 of destinations in order of transmission as shown in FIG. 2.

In the broadcast communication list 40, the name 41a and the telephone number 42a of the destination to which the image data are being transmitted are displayed by the largest characters in the broadcast communication list 40. In the broadcast communication list 40, further, the name 41b and the telephone number 42b of the destination to which the image data are to be transmitted next are displayed by characters of a size smaller than that of the name 41a and the telephone number 42a of the destination to which the data are now being transmitted. In the broadcast communication list 40, further, the names 41c, 41d and the telephone numbers 42c, 42d of the destinations other than the above two destinations are displayed by characters of a size which is smaller than that of the name 41b and the telephone number 42b of the destination to which the image data are to be transmitted next. Thus, the state of transmission of the destination is shown.

In the broadcast communication list 40 as described above, the names and the telephone numbers of the destinations are displayed with characters of three sizes depending upon the state of transmission. Therefore, the operator of the facsimile apparatus 10 can very easily confirm on the display portion 18 at least the name 41a and the telephone number 42a in the broadcast communication list 40 where the image data are currently being transmitted. All that is required is to vary the size of the characters displaying the name 41 and the telephone number 42 of the destination. Even using a display portion 18 capable of displaying monochromatic image only, therefore, the operator can very easily distinguish at least the name 41a and the telephone number 42a where the image data are being transmitted.

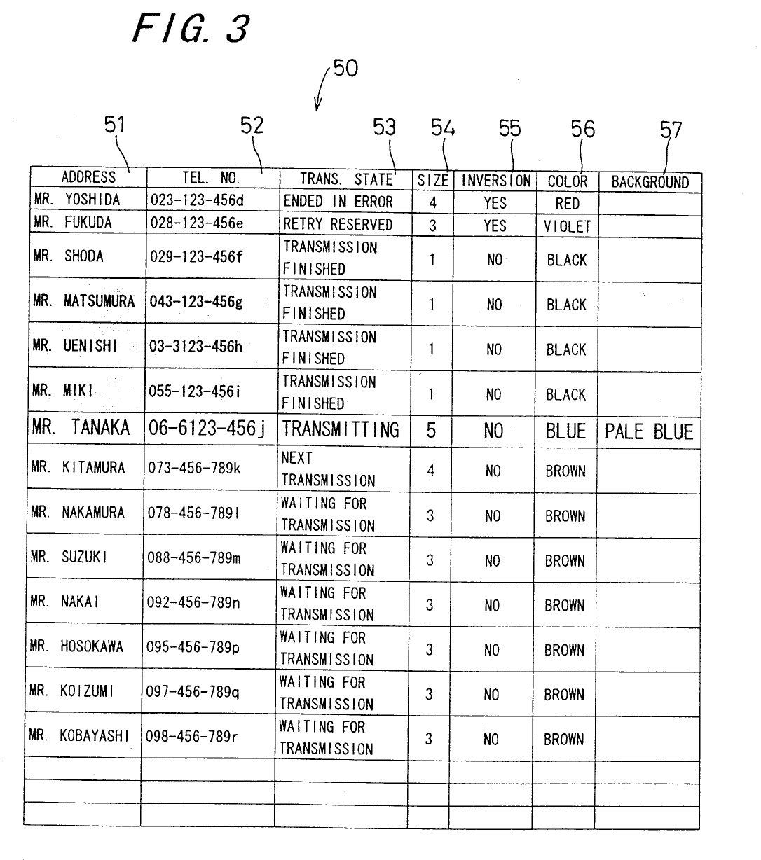

FIG. 3 is a view schematically illustrating a destination address management table 50 stored in the display control portion 19. In this embodiment, the destination address management table 50 includes such data as names 51 of destinations, telephone numbers 52 of destinations, state 53 of transmitting image data, size 54 of characters displayed on the display portion 18, inversion 55 of characters displayed on the display portion 18, color 56 of characters displayed on the display portion 18, and background 57 of characters displayed on the display portion 18. The operator of the facsimile apparatus 10 inputs, in advance, the size 54 of characters displayed on the display portion 18, inversion 55 of characters displayed on the display portion 18, color 56 of characters displayed on the display portion 18, and background 57 of characters displayed on the display portion 18 (hereinafter, these data are collectively called as “display setting information”) depending upon the state of transmission by manipulating the input operation portion 21. The display setting information are stored in the display control portion 19.

The state 53 of transmission is set to be “waiting for transmission”, “next waiting for transmission”, “transmitting”, “transmission finished”, “ended in error” or “retry reserved” for each destination. The “waiting for transmission” is set to the destinations to which the image data have not been transmitted. The “next transmission” setting is for the destination to which the image data are to be transmitted next after the current transmission. The “transmitting” setting is for the destination to which the image data are now being transmitted. The “transmission finished” setting is for the destinations to which the image data have been transmitted. The “ended in error” setting is for the destinations where the processing for transmitting the image data was attempted a predetermined number of times but the transmission of image data could not be completed due to some cause. The “retry reserved” setting is for the destinations where the transmission of the image data was once attempted, but the transmission of image data could not be completed due to some cause, and the transmission of the image data is going to be attempted again.

As for the size 54 of characters, the standard size is represented by “3”, a small size smaller than the standard size “3” is represented by “2”, a minimum size smaller than the small size “2” is represented by “1”, a large size larger than the standard size “3” is represented by “4”, and a maximum size larger than the large size “4” is represented by “5”. Concerning the size 54 of the characters, the operator sets in advance “1, 2, 3, 4 or 5” depending upon the state of transmission.

Concerning the inversion 55 of characters, “yes” is set when the characters are to be inverted, and “no” is set when the characters are not to be inverted. The inversion of characters means that the color of the characters to be displayed and the color of the background surrounding the characters are switched. The inversion 55 of characters is set in advance by the operator. Concerning the color 56 of the characters, the color corresponding to the state of transmission is set in advance by the operator. The background 57 of characters is the color of the background of the region where the characters are displayed. The color of the background corresponding to each state of transmission is set in advance by the operator.

As for the display setting information, when, for example, the state of transmission is “transmitting”, the size of the characters is set to be “5”, the inversion of the characters is set to be “no”, the color of the characters is set to be “blue”, and the color of the background is set to be “pale blue”. The display setting information can be suitably changed according to the properties of the facsimile apparatus 10, properties of other facsimile apparatuses connected to the facsimile apparatus 10 through the telephone line network 30, and properties of the telephone line network 30.

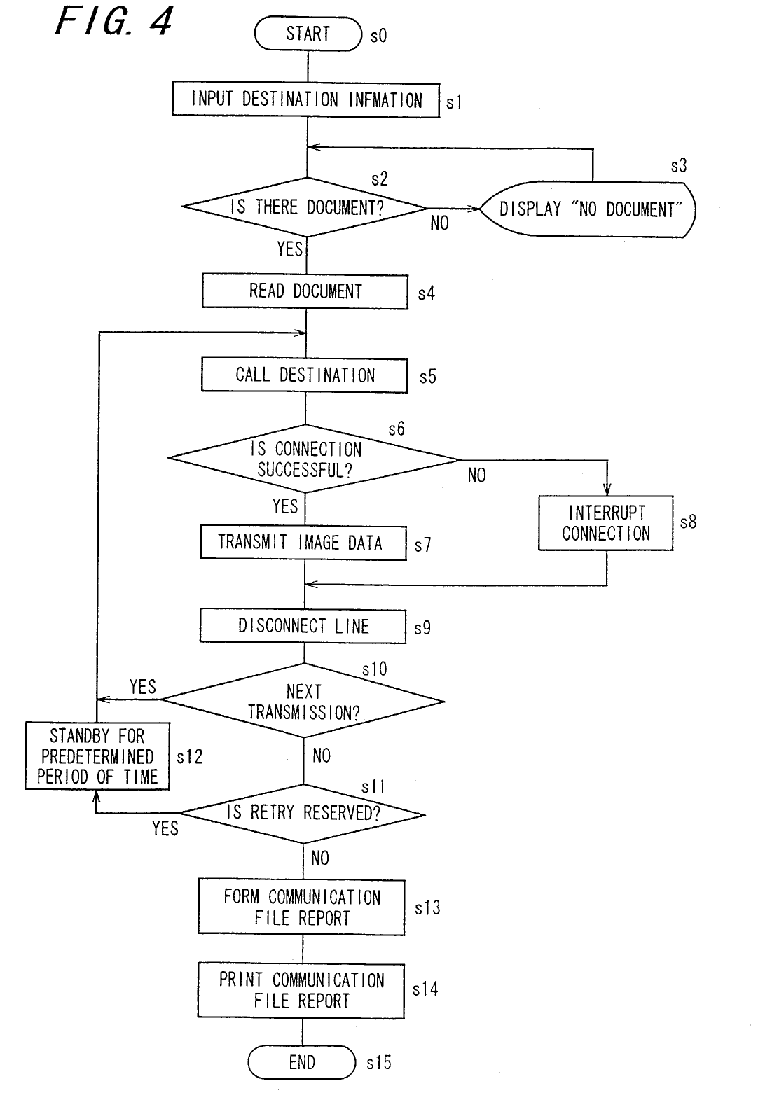

FIG. 4 is a flowchart illustrating the procedure of operation of the facsimile apparatus 10. It is, here, assumed that the display setting information has been input in advance and has been stored in the display control portion 19. The procedure for operating the facsimile apparatus 10 starts at step s0 and proceeds to step s1.

At step s1, the operator of the facsimile apparatus 10 manipulates the input operation portion 21 to input the names and the telephone numbers (hereinafter these data are referred to as “destination information”) of the destinations in order of transmission. The destination information is stored in the display control portion 19, and the procedure proceeds to step s2. At step s1, further, the main control portion 11 forms a destination address management table that have been input and stored in the display control portion 19 and based upon the display setting information that have been stored in the display control portion 19, and stores it in the display control portion 19. In destination address management table, the order of transmission is set according to the order by which the operator has input the names of the destinations. In this case, further, the main control portion 11 sets the state of transmission of all destinations to be “waiting for transmission”.

At step s2, the main control portion 11 judges whether a document has been placed in the image reading portion 22. When it is judged that no document has been placed, the procedure proceeds to step s3. When it is judged that a document with an image that must be transmitted has been placed in the image reading portion 22, the procedure proceeds to step s4. When the procedure proceeds to step s3 as a result of judging at step s2 that no document has been placed in the image reading portion 22, the main control portion 11 at step s3 controls the display control portion 19 so as to display on the display portion 18 that no document has been placed in the image reading portion 22. The procedure, then, returns back to step s2.

FIG. 5 is a view illustrating the display of a broadcast communication list 61 on the display portion 18 at step s4 in the flowchart of FIG. 4. When the procedure proceeds to step s4 as a result of judging at step s2 that the document has been placed in the image reading portion 22, the main control portion 11 at step s4 controls the image reading portion 22 so as to read the document that has been set. Based on the destination address management table, further, the main control portion 11 so controls the display control portion 19 as to display, on the display portion 18, the destination information of destinations to which the image data are to be transmitted in the broadcast communication list 61 as well as the destination information transmission order numerals 61a of the broadcast communication list 61 all by the characters of the standard size “3”, as shown in FIG. 5. The procedure then proceeds to step s5. The image of the document read by the image reading portion 22 at step s4 is converted into electric signals and are encoded to form image data which are, then, stored in the image storage portion 23.

At step s5, the main control portion 11 controls the network control portion 13 so as to call the destination where the state of transmission has been set to be “next transmission” based on the destination address management table, and updates the state of communication of that destination to “transmitting” in the destination address management table.

When there is no destination where the state of transmission has been set to be “next transmission” at step s5, the main control portion 11 controls the network control portion 13 so as to call the destination among those which are “waiting for transmission” which is earliest in order of transmission in the list, and updates the state of communication of that destination to “transmitting” in the destination address management table.

When there is no destination whose state of transmission has been set to be “next transmission” or “waiting for transmission” but when there is a destination where the state of communication has been set to be “retry reserved” at step s5, the main control portion 11 controls the network control portion 13 so as to call the “retry reserved” destination which is first in order of transmission in the list, and updates the state of communication of that destination to “transmitting” in the destination address management table.

Based on the destination address management table, further, the main control portion 11 controls the display control portion 19 so as to display on the display portion 18 the destination information of the destination and the order numeral of transmission whose state of transmission has been updated to “transmitting” by characters of the maximum size “5” on the broadcast communication list. The procedure then proceeds to step s6.

At step s6, the main control portion 11 judges whether successful connection to the communication apparatus at the destination has been made based upon the signal from the network control portion 13. When it is judged that the connection was successful, the procedure proceeds to step s7. When it is judged that the connection has failed, the procedure proceeds to step s8.

When the procedure proceeds to step s7 as a result of judging at step s6 that the successful connection to the communication apparatus at the destination was made, the main control portion 11 at step s7 controls the modem 14 so as to transmit the image data that are stored in the image storage portion 23 and that are to be transmitted, and updates the state of communication of the next destination in the destination address management table to “next transmission”.

Based on the destination address management table, the main control portion 11 then controls the display control portion 19 so as to display on the display portion 18 the destination information of the destination and the order numeral of transmission destination whose state of transmission has been updated to “next transmission” by the characters of the large size “4” while displaying the destination information of the destination and the order numeral of transmission whose state of transmission has been set to “transmitting” by characters of the maximum size “5” on the broadcast communication list. The procedure then proceeds to step s9.

When the procedure proceeds to step s8 as a result of judging at step s6 that the connection to the communication apparatus at the destination has failed, the main control portion 11 at step s8 controls the network control portion 13 so as to interrupt the processing for connection to the destination. The procedure then proceeds to step s9.

At step s9, the main control portion 11 controls the network control portion 13 to disconnect the telephone line network 30. When the procedure proceeds from step s7 to step s9, furthermore, the main control portion 11 updates the state of transmission of the destination where the transmission of image data has finished to “transmission finished”. When the procedure proceeds from step s8 to step s9, on the other hand, the main control portion 11 updates the state of transmission at the destination where the connection to the communication apparatus has failed to “retry reserved”.

Further, when the procedure proceeds from step s7 to step s9, the main control portion 11 controls the display control portion 19 so as to display on the display portion 18 the destination information of the destination and the order numeral of transmission where the state of transmission has been set to be “transmission finished”, based on the destination address management table, by the characters of the minimum size “1” on the broadcast communication list. The procedure then proceeds to step s10.

Further, when the procedure proceeds from step s8 to step s9, the main control portion 11 controls the display control portion 19 so as to display on the display portion 18 the destination information of the destination and the order numeral of transmission where the state of transmission has been set to be “retry reserved”, based on the destination address management table, by the characters of the standard size “3” on the broadcast communication list. The procedure then proceeds to step s10.

At step s10, the main control portion 11 determines, based on the destination address management table, whether there is a destination whose state of transmission has been set to be “next transmission”. When there is a destination whose state of transmission has been set to be “next transmission”, the procedure returns back to step s5. When there is no destination where the state of transmission has been set to be “next transmission”, the procedure proceeds to step s11.

When the procedure proceeds to step s11 as a result of judging at step s10 that there is no destination where the state of communication has been set to be “next transmission”, the main control portion 11 judges at step s11, based on the destination address management table, whether there is any destination whose state of transmission is set to “retry reserved”. When it is judged that there is a destination whose state of communication has been set to be “retry reserved”, the procedure proceeds to step s12. When it is judged that there is no destination where the state of transmission has been set to be “retry reserved”, the procedure proceeds to step s13. Further, at step s11, when more than a predetermined number of attempts have been made to transmit the image data to the destination whose state of transmission has been set to “retry reserved”, the main control portion 11 updates the state of transmission at the destination to “ended in error”, and stops further attempts to transmit the image data to the destination where the state of transmission has been set to be “ended in error”

When the procedure proceeds to step s12 as a result of judging at step s11 that there is a destination whose state of transmission has been set to be “retry reserved”, the main control portion 11 at step s12 updates the state of transmission of the first among the destinations whose state of transmission has been set to be “retry reserved” to be “next transmission”, and stands by until a predetermined period of time elapses. After the passage of the predetermined period of time, the procedure returns back to step s5.

FIG. 6 is a view illustrating the display of a broadcast communication list 62 on the display portion 18 at step s13 in the flowchart of FIG. 4. When the procedure proceeds to step s13 as a result of judging at step s11 that there is no destination where the state of transmission has been set to be “retry reserved”, the main control portion 11 makes a communication file report based on the destination address management table and, further, controls the display control portion 19 so as to display on the display portion 18 the destination information of all destinations and the order numerals 62a of transmission with characters of the minimum size “1” on the broadcast communication list 62. The procedure then proceeds to step s14.

At step s14, the main control portion 11 controls the image printing portion 24 so as to print the communication file report formed at step s13 on printing paper, and the procedure proceeds to step s15 to end the whole procedure.

FIG. 7 is a view illustrating the display of a broadcast communication list 63 on the display portion 18. As shown in FIG. 7, the main control portion 11 controls the display control portion 19 so as to display on the display portion 18 the destination information and the order numeral 63a of transmission of the destination where the state of transmission has been set to “transmitting”, based on the destination address management table, by the characters of the maximum size “5”, as well as to display the destination information and the order numerals 63b of transmission of the destinations where the state of transmission has been set to be “waiting for transmission” by the characters of the standard size “3”.

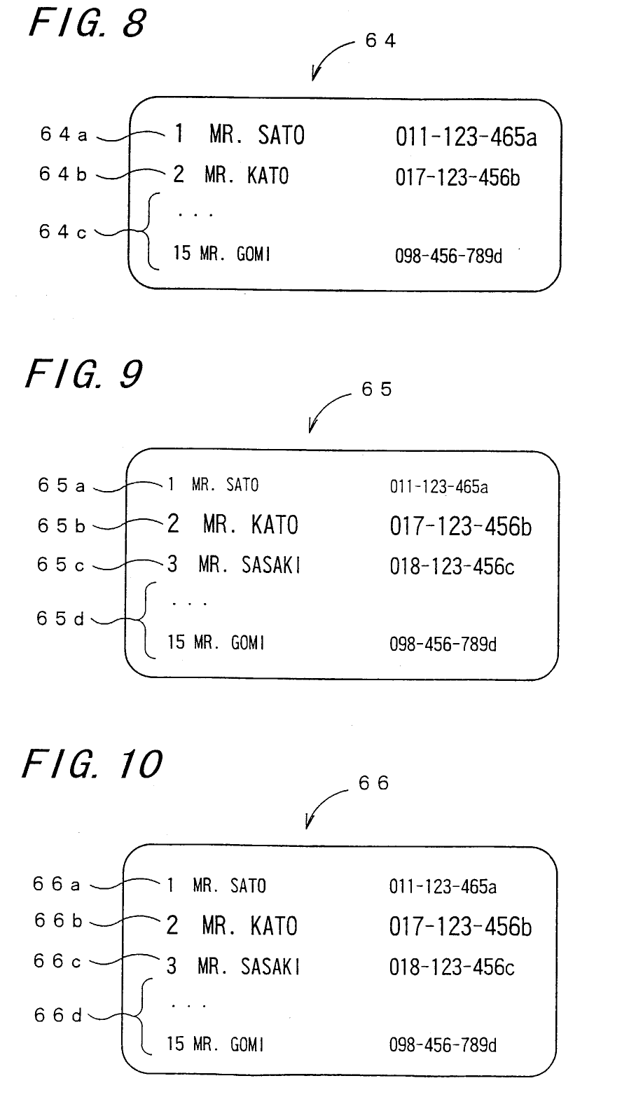

FIG. 8 is a view illustrating the display of a broadcast communication list 64 on the display portion 18. As shown in FIG. 8, the main control portion 11 controls the display control portion 19 so as to display on the display portion 18 the destination and the order numeral 63a of transmission of the destination whose state of transmission has been set to “transmitting”, based on the destination address management table, by characters of the maximum size “5”, to display the destination information and the order numerals 63b of transmission of the destinations whose state of transmission has been set to be “next transmission” by characters of the large size “4”, as well as to display the destination information and the order numerals 64c of transmission of the destinations whose state of transmission has been set to be “waiting for transmission” by characters of the standard size “3”.

FIG. 9 is a view illustrating the display of a broadcast communication list 65 on the display portion 18. As shown in FIG. 9, the main control portion 11 controls, based on the destination address management table, the display control portion 19 so as to display on the display portion 18 the destination information and the order numerals 65a of transmission of the destinations whose state of transmission has been set to “transmission finished” with characters of the minimum size “1”, to display the destination information and the order numeral 65b of transmission of the destination whose state of transmission has been set to “transmitting” with characters of the maximum size “5”, to display the destination information and the order numeral 65c of transmission of the destination whose state of transmission has been set “next transmission” with characters of the large size “4”, as well as to display the destination information and the order numerals 65d of transmission of the destinations whose state of transmission has been set to be “waiting for transmission” with characters of the standard size “3”.

FIG. 10 is a view illustrating the display of a broadcast communication list 66 on the display portion 18. As shown in FIG. 10, the main control portion 11 controls the display control portion 19 so as to display on the display portion 18 the destination information and the order numerals 66a of transmission of the destinations whose state of transmission has been set to “retry reserved”, based on the destination address management table, with characters of the standard size “3”, to display the destination information and the order numeral 66b of transmission of the destination whose state of transmission has been set to be “transmitting” with characters of the maximum size “5”, to display the destination information and the order numeral 66c of transmission of the destination whose state of transmission has been set to “next transmission” with characters of the large size “4”, as well as to display the destination information and the order numerals 66d of transmission of the destinations whose state of transmission has been set to “waiting for transmission” with characters of the standard size “3”.

FIG. 11 is a view illustrating the display of a broadcast communication list 67 on the display portion 18. As shown in FIG. 11, the main control portion 11 controls the display control portion 19 so as to display on the display portion 18 the destination information and the order numeral 67a of transmission of the destination whose state of transmission has been set to be “transmitting”, based on the destination address management table, with characters of the maximum size “5” while inverting the colors of the characters and of the background region surrounding the characters.

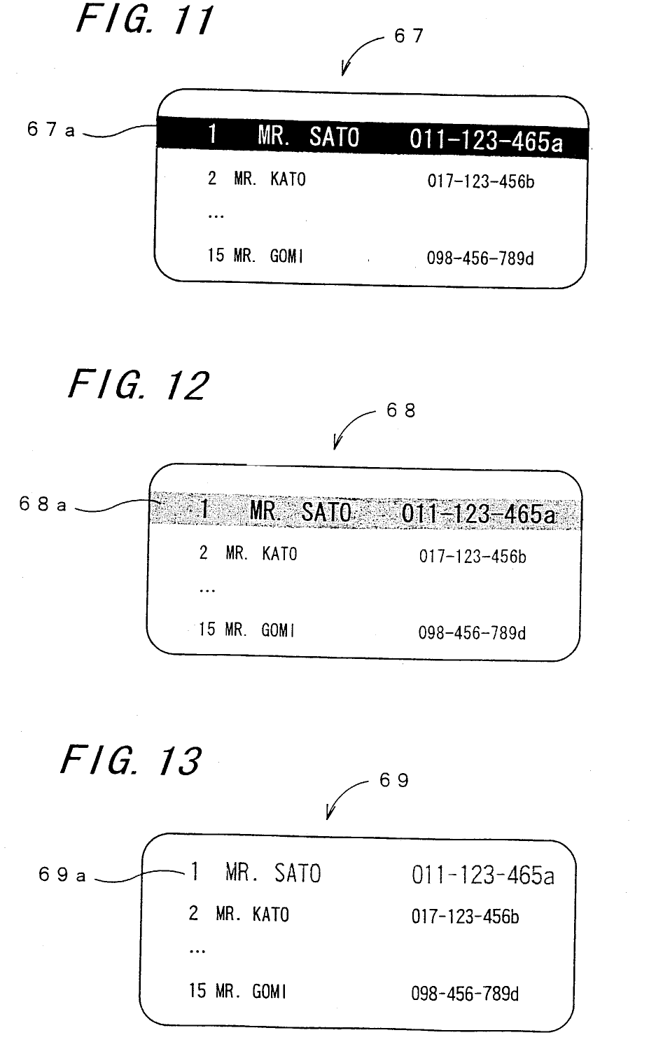

FIG. 12 is a view illustrating the display of a broadcast communication list 68 on the display portion 18. As shown in FIG. 12, the main control portion 11 controls the display control portion 19 so as to display on the display portion 18 the destination information and the order numeral 68a of transmission of the destination whose state of transmission has been set to be “transmitting”, based on the destination address management table, by the characters of the maximum size “5” while selecting the background color of the region surrounding the characters to be different from the color of the remaining regions.

FIG. 13 is a view illustrating the display of a broadcast communication list 69 on the display portion 18. As shown in FIG. 13, the main control portion 11 controls the display control portion 19 so as to display on the display portion 18 the destination information and the order numeral 69a of transmission of the destination whose state of transmission has been set to “transmitting”, based on the destination address management table, with characters of the maximum size “5” while selecting the color of the characters to be different from the color of the rest of the destinations.

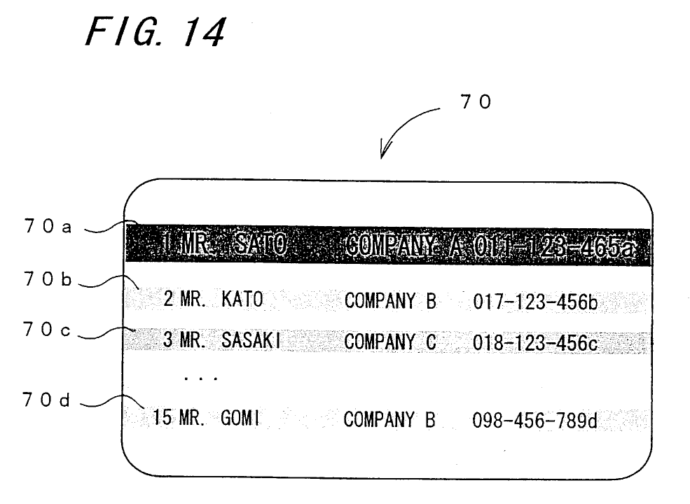

FIG. 14 is a view illustrating the display of a broadcast communication list 70 on the display portion 18. The destination information includes the addresses and telephone numbers of the destinations, as well as the names of the companies located at those destinations. As shown in FIG. 14, the main control portion 11 controls the display control portion 19 so as to display on the display portion 18 the destination information and the order numeral 70a of transmission of the destination whose state of transmission has been set to “transmitting”, based on the destination address management table, with characters of the maximum size “5”. Further, since the destination information of the destination whose state of transmission has been set to be “transmitting” and the order numeral 70a of transmission belong to a company “A”, the main control portion 11 controls the display control portion 19 so as to display, on the display portion 18, the background of the region surrounding the characters by a color different from that of the rest of the destinations. The main control portion 11 controls the display control portion 19 so as to display on the display portion the background of the region surrounding the characters of the destination information and the order numeral 70b of transmission of the destination belonging to a company “B” by a color different from that of the rest of the destinations, and the background of the region surrounding the characters of the destination information and the order numeral 70c of transmission of the destination belonging to a company “C” by a color different from that of the rest of the destinations. With one look at the display portion 18, therefore, the operator can easily confirm the organizations located at the destinations and the regions where the destinations are located.

If the destination information includes the names of companies located at the destinations as well as the addresses and telephone numbers of the destinations, the names of the companies are displayed as shown in the broadcast communication list 70 in FIG. 14. The destination information may further include prefectures, regions where they are located, in addition to the addresses and telephone numbers of the destinations, and hence prefectures may be displayed.

According to the facsimile apparatus 10 of this embodiment as described above, the display portion 18 displays a broadcast communication list including destination information of all destinations to which the image data are to be transmitted when the broadcast communication function is executed. Depending upon the state of transmission, further, the destination information is displayed by the characters of a different size, of a different color and on a background of a different color in the region where the characters are displayed, or at least two of these three differences. With one look at the display portion 18, therefore, the operator can very easily confirm the state of transmission of data, such as “being transmitted”, “waiting for transmission” or “transmission finished” and, hence, to correctly grasp the progress of the broadcast communication of one item of data.

According to the facsimile apparatus 10 of this embodiment, further, the destination information of the destination to which the image data are currently being transmitted are displayed with characters of a size and by a color different from those of the rest of the destination information, or on the background of a different color in the region where the characters are displayed, or with combination of at least two of these differences. With one look at the display portion 18, therefore, the operator can easily confirm the destination to which the image data are currently being transmitted to correctly grasp the progress of the broadcast communication of one item of data.

Thus, the facsimile apparatus 10 of this embodiment makes it possible to express, on a screen of a limited size of the display portion 18, the state of transmission in a variety of ways that can be easily recognized by the operator from the standpoint of ergonomics. Accordingly, the operator can correctly grasp progress of broadcast communication on one item of data taking place and to take quick measures such as interrupting the transmission if problems occur.

In the facsimile apparatus 10 of this embodiment, the image data processing is conducted by the main control portion 11. It is, however, also possible to separately provide a portion for exclusively processing the image. This makes it possible to conduct the transmission processing and the image processing in parallel and smoothly.

In the facsimile apparatus 10 of this embodiment described above, it is desired that the display portion 18 is capable of displaying the image in a multiplicity of colors. However, the display apparatus may be the one that expresses the image in two colors only of black and white. In this case, the destination information of the destination to which the data are being transmitted may be displayed by the characters of a size different from that of the rest of destination information, or the colors of the characters displaying the destination information and the background region around the destination information may inverted from those of the rest of destination information. By taking a look at the display portion 18, therefore, the operator can easily confirm the destination to which the image data are being transmitted and so correctly grasp the progress of the broadcast communication of one item of data.

In the facsimile apparatus 10 of this embodiment, further, the main control portion 11 controls the display control portion 19 so as to display on the display portion 18 a broadcast communication list including the destination information of all destinations to which the image data are to be transmitted. However, the display control portion 19 may alternately be controlled so as to scroll the display on the display portion 18 in a state of displaying a particular part of the broadcast communication list at the center of the display portion 18 at all times, for instance the destination information of the destination whose state of transmission is “transmitting”.

The communication apparatus in this embodiment is a facsimile apparatus 10 which can be connected to the telephone line network 30. The communication apparatus, however, may be an Internet facsimile apparatus which is connected to the Internet via a local area network (LAN) and transmits the image data to other communication terminals by e-mail. In this case, the destination information includes an e-mail address.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus equipped with a broadcast communication function for transmitting the same data to a plurality of destinations successively, comprising:
storage means for storing data to be transmitted, destination information related to the destinations to which the data are to be transmitted, and a state of transmission of the data to the destinations;
display means for displaying the destination information; and
display control means for controlling the display means so as to display a list of destination information of all destinations to which the data are to be transmitted when a broadcast communication function is to be executed and so as to display the respective destination information in a predetermined display mode in accordance with the respective states of transmission.

2. The communication apparatus of claim 1, wherein the state of transmission indicates an order of transmitting the data and whether the data are being transmitted, and
the display control means controls the display means so as to display the destination information to arrange them in the order of transmission based upon the state of transmission and so as to display the destination information of the destination to which the data are being transmitted in a display mode different from that of the rest of destination information.

3. The communication apparatus of claim 1, wherein the display control means controls the display means so as to display the destination information by characters whose size differs depending upon the state of transmission.

4. The communication apparatus of claim 1, wherein the display control means controls the display means so as to display the destination information by characters whose color differs depending upon the state of transmission.

5. The communication apparatus of claim 1, wherein the display control means controls the display means so as to display a background of a region for displaying the destination information by a color that differs depending upon the state of transmission.

6. The communication apparatus of claim 2, wherein the display control means controls the display means so as to display, as the display mode of the destination information being transmitted, a color of the characters representing the destination information and a background color of a region displaying the destination information, inverted from the display mode of the rest of destination information.

7. The communication apparatus of claim 1, wherein the display control means determines the display mode by combining at least two of a different character size, a different character color and a different background color in the region for displaying the characters.

8. The communication apparatus of claim 1, wherein the destination information includes an organization belonging to the destination and/or a region of the destination, and the display control means controls the display means so as to display the destination information in a predetermined display mode corresponding to the organization and the region.
